(19) United States
(12) Patent Application Publication
(10) Pub. No.: US 2003/0192570 A1
(43) Pub. Date: Oct. 16, 2003

(54) Method and apparatus for wafer cleaning

(75) Inventors: Randhir Thakur, San Jose, CA (US); Steven Verhaverbeke, San Francisco, CA (US); J. Kelly Truman, Morgan Hill, CA (US)

Correspondence Address: APPLIED MATERIALS, INC., 2881 SCOTT BLVD. M/S 2061, SANTA CLARA, CA, 95050, US

(73) Assignee: Applied Materials, Inc.

(21) Appl. No.: 10/121,635

(22) Filed: Apr. 11, 2002

(51) Int. Cl. B08B 3/02

(52) U.S. Cl. 134/1.3; 134/198; 134/902; 134/144; 134/153; 134/33; 134/37

(57) ABSTRACT

A single wafer cleaning apparatus that includes a rotatable bracket that can hold a wafer, a rinse fluid having a first surface tension, a second fluid having a second surface tension lower than the first surface tension, a first nozzle capable of applying the rinse fluid at a first location on the wafer positioned in the bracket, second nozzle capable of applying the second fluid at a second location on the wafer where the second location is inboard of the first location, and the first nozzle and the second nozzle are capable of moving across the wafer to translate the first location and the second location from the wafer center to the wafer outer edge.

### FIELD OF THE INVENTION

The present invention pertains in general to wafer processing and in particular to a single wafer cleaning process.

### BACKGROUND OF THE INVENTION

One of the most important tasks in semiconductor industry is the cleaning and preparation of the silicon surface for further processing. The main goal is to remove contaminants such as particles from the wafer surface and to control chemically grown oxide on the wafer surface. Modern integrated electronics would not be possible without the development of technologies for cleaning and contamination control, and further reduction of the contamination level of the silicon wafer is mandatory for the further reduction of the IC element dimensions. Wafer cleaning is the most frequently repeated operation in IC manufacturing and is one of the most important segments in the semiconductor-equipment business, and it looks as if it will remain that way for some time. Each time device-feature sizes shrink or new tools and materials enter the fabrication process, the task of cleaning gets more complicated.

Today, at 0.18-micron design rules, 80 out of ˜400 total steps will be cleaning. While the number of cleans increases, the requirement levels are also increasing for impurity concentrations, particle size and quantity, water and chemical usage and the amount of surface roughness for critical gate cleans. Not only is wafer cleaning needed now before each new process sequence, but also additional steps are often required to clean up the fabrication process tools after a production run.

Traditionally, cleaning has been concentrated in the front end of the line (FEOL) where active devices are exposed and more detailed cleans required. A primary challenge in FEOL cleans is the continuous reduction in the defect levels. As a rule, a “killer defect” is less than half the size of the device line width. For example, at 0.25 μm geometries, cleans must remove particles smaller than 0.12 μm and at 0.18 μM, 0.09 μm particles.

Most cleaning methods can be loosely divided into two big groups: wet and dry methods. Liquid chemical cleaning processes are generally referred to as wet cleaning. They rely on combination of solvents, acids and water to spray, scrub, etch and dissolve contaminants from the wafer surface. Dry cleaning processes use gas phase chemistry, and rely on chemical reactions required for wafer cleaning, as well as other techniques such as laser, aerosols and ozonated chemistries. Generally, dry cleaning technologies use less chemicals and are less hazardous for the environment but usually do not perform as well as wet methods, especially for particle removal.

For wet-chemical cleaning methods, the RCA clean, developed in 1965, still forms the basis for most front-end wet cleans. A typical RCA-type cleaning sequence starts with the use of an H2SO4/H2O2 solution followed by a dip in diluted HF (hydrofluoric acid). A Standard Clean first operation (SC1) can use a solution of NH4OH/H2O2/H2O to remove particles, while a Standard Clean second operation (SC2) can use a solution of HCl/H2O2/H2O to remove metals. Despite increasingly stringent process demands and orders-of-magnitude improvements in analytical techniques, cleanliness of chemicals, and DI water, the basic cleaning recipes have remained unchanged since the first introduction of this cleaning technology. Since environmental concerns and cost-effectiveness were not a major issue 30 years ago, the RCA cleaning procedure is far from optimal in these respects.

Marangoni drying is a commonly used method to dry wafers after being processed in a wet bench. The method uses a difference in surface tension gradients of IPA and DI water to help remove water from the surface of the wafer. This surface tension phenomenon is known as the Marangoni effect. The Marangoni effect is characterized in thin liquid films and foams whereby stretching an interface causes the surface excess surfactant concentration to decrease, hence surface tension to increase; the surface tension gradient thus created causes liquid to flow toward the stretched region, thus providing both a “healing” force and also a resisting force against further thinning.

FIG. 1 is an illustration of the results of a Marangoni force. Initially, a continuous flow of rinsing liquid is supplied on the wafer surface through a narrow dispensation tube. The wafer rotates at moderate speed. The dispenser tube slowly moves from the center of the substrate towards the edge. A second nozzle is mounted on the trailing side of the liquid dispenser tube. This second nozzle dispenses a tensioactive (surface tension active) vapor, such as IPA vapor, which reduces the surface tension of the liquid and creates an efficient Marangoni force. The unique interaction between the Marangoni effect and the rotational forces results in high-performance liquid removal. In a Marangoni dryer, the drying is performed by the Marangoni effect in cold DI water, and the wafer is rendered completely dry without evaporation of water or condensation of IPA.

The Marangoni technique can be practiced by the slow batch withdrawal of wafers from a DI water bath to an environment of isopropyl alcohol (IPA) and nitrogen such that only the portion of the surface that is at the interface of the liquid and vapor phases is “drying” at any one time. In this way, uncontrolled evaporative drying on the wafer is prevented. IPA drying provides a great advantage in hydrophobic cleaning steps such as pre-gate, pre-silicide and pre-contact cleans.

During the rinse operation, a nozzle can flow fluid such as DI water onto the wafer. The water flowing onto the wafer can splash and create a spray. The splash back of the spray onto the wafer can bead up especially on hydrophobic surfaces. During a later drying phase, the water can evaporate to leave a watermark. Watermarks can be the result of an outline of the water bead that can contain a redeposit of the particles that were intended to be removed by the rinse operation. Alternatively, these watermarks can be the result of hydrolysis of the DI water, producing small amounts of hydroxide ion, which, in the presence of oxygen, allow the silicon substrate to oxidize, creating an oxide deposit upon final drying.

Megasonic agitation is the most widely used approach to adding energy (at about 800 kHz or greater) to the wet cleaning process. The physics behind how particles are removed, however, is not well understood. A combination of an induced flow in the cleaning solution (called acoustic streaming), cavitation, the level of dissolved gases, and oscillatory effects are all thought to contribute to particle removal performance.

### SUMMARY OF THE INVENTION

The present invention provides for improved wafer cleaning in a single wafer cleaning chamber. In one embodiment, a pair of nozzles can generate a Marangoni force by flowing fluids having different surface tension characteristics onto a top surface of a rotating wafer and where the Marangoni force can act on particles remaining on the wafer surface. Such particles can be silicates that can be the product of an HF etch or a cleaning operation and where the particles can be directed by the Marangoni force to the wafer outer edge and removed from the wafer surface. The Marangoni force can be created by flowing a rinse fluid from a first nozzle that can be deionized (DI) water and by flowing a second fluid from a second nozzle that can be IPA (isopropyl alcohol) vapor in nitrogen gas (N₂). The Marangoni force can be created where the force is in a direction to move the contaminants toward the outer edge (outer diameter) of the wafer.

In one embodiment of the present invention, a summation of forces can act to maintain a wafer in a wafer holding bracket. A transducer plate can be positioned beneath the wafer holding bracket in the single wafer cleaning chamber. The wafer holding bracket can translate to place the wafer in a process position above the transducer plate where a small gap can exist between the transducer plate and the wafer. The total force acting on the wafer to maintain the wafer in the wafer holding bracket can include a number of different forces.

During various process cycles that can include the rinse cycle, forces acing on the wafer can include fluids flowing from the nozzles where the force of the fluids striking the wafer top surface acts as a “down” force. Other down forces acting on the wafer can be, for example, gravity, and air flow from an air filter above. A flow of fluid through the transducer plate that can strike the wafer bottom surface can be one example of an “up” force on the wafer as can vibration of the wafer holding bracket during rotation. Capillary forces created by a fluid placed between the transducer plate and the wafer can act to restrain the wafer from movement away from the transducer plate.

During wafer drying portions of the cleaning cycle, a gas may flow from one or more nozzles to strike the wafer top surface and flow into a gap between the wafer and the transducer plate. A high wafer rotation rate can create non-symmetric air flow across the wafer top surface versus the wafer bottom surface, i.e. in the gap between the wafer and the transducer plate. The result can be a pressure differential acting on the wafer and where this differential can result in a down force onto the wafer, i.e. a Bernoulli force. As such, in the drying phase where wafer rotation rates are high, yet no capillary force exists, the Bernoulli force can act on the wafer to maintain the wafer in position in the wafer holding bracket.

In one embodiment of the present invention, UV light bulbs are placed into the single wafer cleaning chamber to flood the interior, and the wafer top surface with UV light. UV light can break down some contaminants such as any remaining organic molecules from previous operations on the wafer and where the smaller (lower molecular weight) molecules can be more easily removed by the DI water rinse operation. The UV light can break down the organic molecules by direct impingement onto the molecules during a dry cycle prior to the rinse. The UV light can further contribute to this breakdown by ozonating the DI water during the rinse phase where the ozone can also act on the organic molecules to break them down into smaller molecules. Finally, after a final rinse, UV light can be used to accelerate the oxidation of exposed bare silicon on the wafer top surface as a protective coating.

In one embodiment, a nozzle is angled so that flow of a liquid is angled incident to a rotating wafer at an angle. Liquids, such as the rinse water, striking the wafer at the incident angle can reduce the amount of splashing that occurs as opposed to fluids that are vertically incident to the wafer surface.

### BRIEF DESCRIPTION OF THE DRAWINGS

The present invention is illustrated by way of example and not limitation in the figures of the accompanying drawings, in which like references indicate similar elements and in which:

FIG. 1 is an illustration of the results of a Marangoni force.

FIG. 2A is an illustration of one embodiment of a single wafer cleaning chamber.

FIG. 2B is an illustration of one embodiment of a dual-nozzle arrangement for cleaning a wafer.

FIG. 2C is an illustration of an alternate embodiment having an angled nozzle.

FIG. 2D is an illustration of a top view of the alternate embodiment of the angled nozzle.

FIG. 3 is an illustration of one embodiment of forces acting on a particle during a wafer rinse operation.

FIG. 4A is an illustration of one embodiment of a wafer during a rinse operation.

FIG. 4B is an illustration of one embodiment of the wafer during a drying operation.

FIG. 5 is flow diagram of one embodiment of a method for rinsing a wafer while maintaining the wafer in a bracket.

FIG. 6A is an illustration of UV light breaking down organic molecules.

FIG. 6B is an illustration of UV light accelerating the formation of a thin silicon oxide coating over the wafer top surface.

FIG. 7 is a flow diagram of one embodiment of a method for applying UV light to a wafer surface.

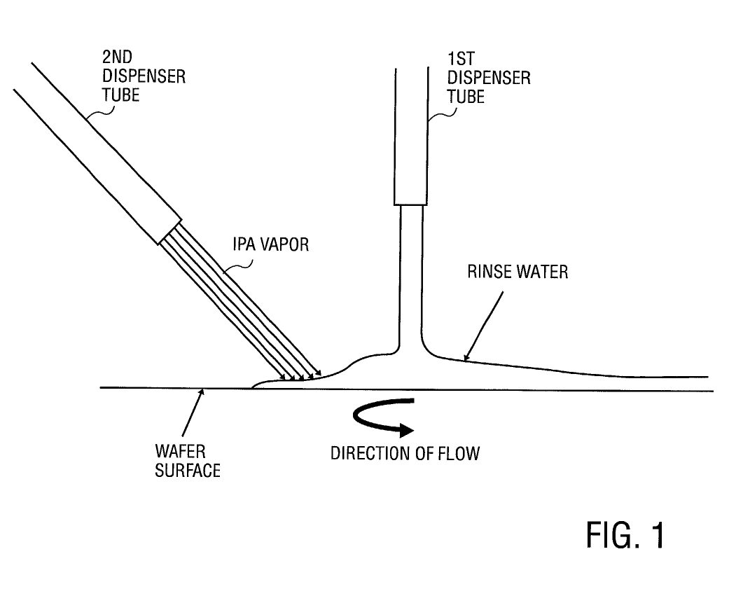

### DETAILED DESCRIPTION

For purposes of discussing the invention, it is to be understood that various terms are used by those knowledgeable in the art to describe apparatus, techniques, and approaches. In the following description, for purposes of explanation, numerous specific details are set forth in order to provide a thorough understanding of the present invention. It will be evident, however, to one skilled in the art that the present invention may be practiced without these specific details. In some instances, well-known structures and devices are shown in gross form rather than in detail in order to avoid obscuring the present invention. These embodiments are described in sufficient detail to enable those skilled in the art to practice the invention, and it is to be understood that other embodiments may be utilized and that logical, mechanical, chemical, and other changes may be made without departing from the scope of the present invention.

The present invention is a method and apparatus for enhancing the cleaning operation on a wafer in a single wafer cleaning chamber. The method and apparatus are specifically useful for single wafer cleaning, but the method and apparatus disclosed may also be used in applications where more than one wafer is cleaned at a time. In one aspect of the present invention, a surface tension force, i.e. a Marangoni force, is created on a rotating wafer to assist in removing contaminants produced by previous cleaning and etch operations. In another aspect of the presenting invention, a number of forces can be generated onto the wafer such that a summation of these forces can result in a down force onto the wafer to maintain the wafer in position on a wafer holding bracket. It is a further aspect of the present invention to direct a UV light onto the wafer to breakup residual organics into smaller molecules that are easier to rinse away and further, where the UV light can assist in creating a thin silicon oxide protective coating on the wafer. In still another aspect of the present invention, a nozzle can be used in a rinse cycle where the nozzle is angled to flow a liquid that is incident to the wafer at an angle to reduce splash back that might contribute to watermarks on the wafer surface.

A single wafer cleaning chamber can be used to clean wafers before and after a variety of wafer processes, such as, for example, deposition of a metallized film, photoresist patterning, or Rapid Thermal Processes where RTP can be used for such process as wafer annealing, doping, and oxide growth. The wafer cleaning process can include several types of cleaning cycles as well as an hydrofluoric acid (HF) etch on the wafer to remove oxides. As a result, there are usually contaminants such as particulate matter (particles) in the rinse water that can remain on the wafer, where such particles can be, for example, silicates. It is important to remove those contaminants from the wafer surface. When applying a liquid to remove particles, a boundary layer, i.e. a thin static layer of liquid, can exist near the wafer surface that can contain these particles. Under these conditions, electrostatic repulsion forces may only exist once the particle is removed a certain distance from the wafer. As such, there may be no force strong enough to remove the particles from the wafer. Therefore, to remove the particles from the viscous boundary layer on a rotating wafer (at 1600 rpm a boundary layer of 12.5 microns can exist), a Marangoni force can be developed to act on these particles, and in particular, the particles made of silicates.

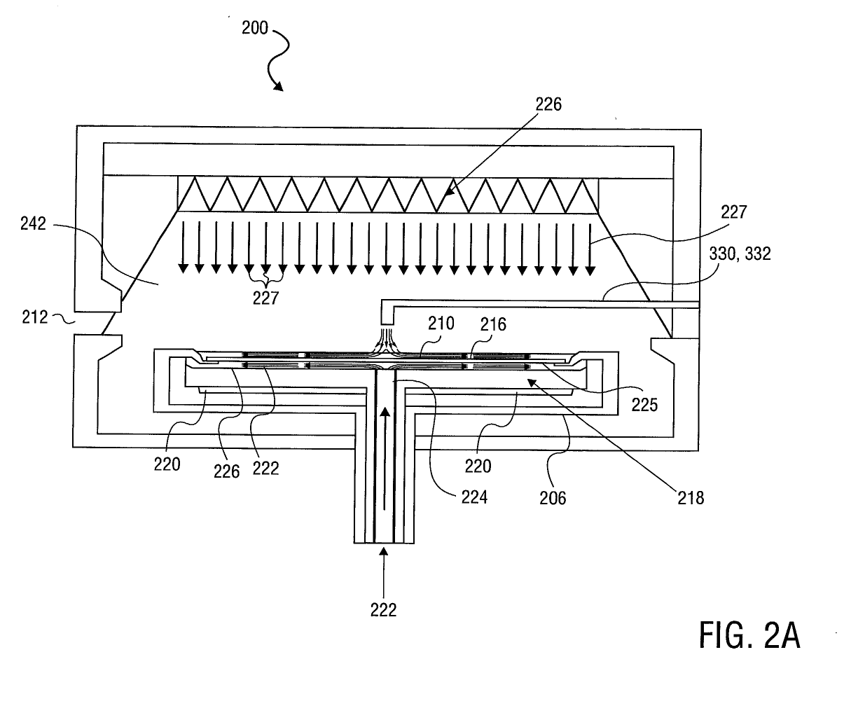

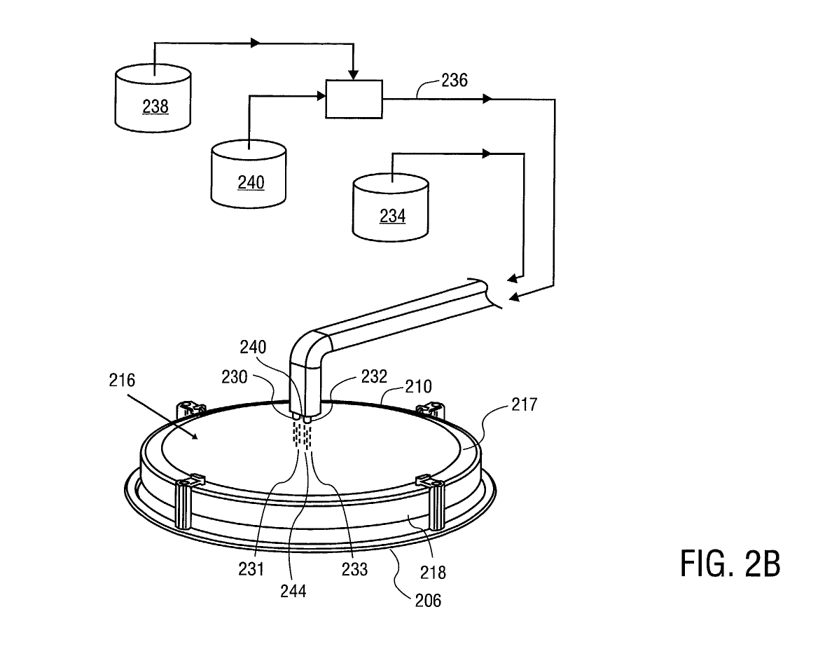

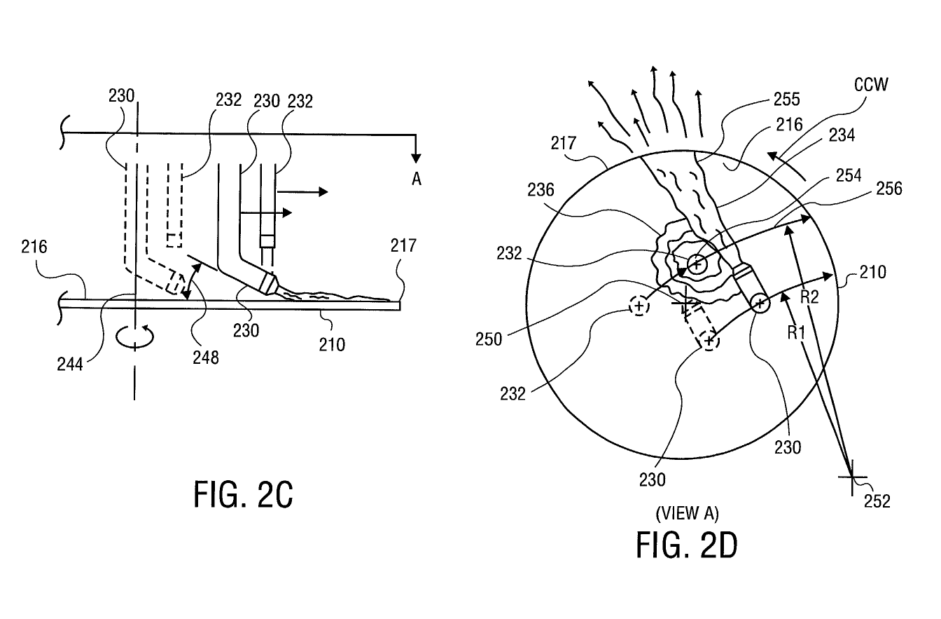

FIG. 2A is an illustration of one embodiment of a single wafer cleaning chamber. FIG. 2B is a perspective view of one embodiment of a dual-nozzle arrangement for dispensing chemicals onto a wafer. As shown in FIG. 2A, a single wafer cleaning chamber 200 can contain a rotatable wafer holding bracket 206. A robot arm (not shown) holding a wafer 210 can enter the chamber 200 through a slit 212. The arm can place the wafer 210 onto the bracket 206 where the wafer 210 is initially maintained in position on the bracket 206 by gravity. In one embodiment, the bracket 206 does not have any features that contact the wafer 210 to maintain the wafer 210 in position on the bracket 206. The bracket 206 can be raised so that the wafer 210 and robot arm are clear from other components in the chamber 200 during a wafer transfer.

Once the wafer 210 is placed onto the bracket 206, the bracket 306 can be lowered to a process position as shown. This process position can place the wafer 310 a short distance above a circular plate 218. The circular plate 218 can contain transducers 220 that are capable of emitting sound in the megasonic frequency range. A fluid feed port 224 can be added to the transducer plate 218 to fill an approximate 3 millimeter (mm) gap 326 between the transducer plate 218 and the wafer 210 with a liquid 222 at various times during wafer 210 processing. The liquid 222 can act as a carrier for transferring megasonic energy onto the wafer bottom surface 225. The top of the single wafer cleaning chamber 200 can contain a filter 226 to clean air that is flowing 227 into the process chamber 200 and onto a wafer top surface 216.

As shown in FIG. 2B, in one embodiment, two nozzles 230 and 232 can be positioned to each direct flow of a gas, vapor, or a liquid onto the wafer top surface 216. The first nozzle 230 can flow cleaning solutions 234 such as are used in the RCA cleaning processes to contact the wafer 210 at a first location 231. The second nozzle 332 can be used, such as in the rinse cycle, to flow IPA vapor 236, or some other surface tension reducing chemical, onto the wafer top surface 216 at a second location 233. The distance 240 between the two nozzles 230 and 232, edge-to-edge, can be approximately in the range of 0.10-0.50 inch such that the streams 231 and 233 from the two nozzles 230 and 232 can be separated by approximately in the range of 0.10-0.50 inch. IPA vapor 236 can be created such as, for example, by mixing a gas 238, with a stream of IPA liquid 240 prior to entering the process chamber 200. The gas 238 can be an inert gas 238 such as, for example, nitrogen (N₂). The two nozzles 230 and 232 can be capable of moving such as, for example, by pivot or by linear translation. Moving the nozzles 230 and 232 can move the contact points (first location and second location respectively) 231 and 233 for the chemicals 236 and 234 from the wafer center 244 toward the wafer edge 217. The two nozzles 230 and 232 can be attached to each other to move in unison or the two nozzles 230 and 232 can move independently to be directed to have either nozzle 230 or 232 remain stationary, to have the two nozzles 230 and 232 move in unison or to move separately.

In one embodiment, the translating nozzles 230 and 232 can be used to create a Marangoni force for removing particles from the wafer surface. The liquid 234 used can be highly purified water, such as, for example, DI water, and can be applied onto the wafer 210 to flush away the particulate matter. A stream of the water 234 can be initially applied near the wafer center 244 by the first nozzle 230. The IPA vapor nozzle 232 can be positioned offset from the first nozzle 230, i.e. behind the first nozzle 230 relative to the direction of travel for the two nozzles 230 and 232. During a cycle, such as, for example, a rinse cycle, the nozzles 230 and 232 can translate in unison to move progressively out toward the wafer outer edge 217 (outer diameter). With the rinse water 234 dispensed onto the wafer 210, the IPA vapor nozzle 232 can apply a stream of IPA vapor 236 to contact the rinse water 234 on the inboard side of the wafer 210.

FIGS. 2C and 2D are illustrations of an alternate embodiment of a nozzle arrangement for creating the Marangoni force in a rinse cycle. FIG. 2C is an illustration of a cross-section of an angled nozzle applying rinse water to a wafer surface and a vertical nozzle applying IPA vapor. FIG. 2D is an illustration of a top-down view of the angled nozzle and the IPA vapor nozzle. In the rinse cycle, the Marangoni force can be created by flowing IPA vapor 236 onto an inboard side 254 of rinse water that has been applied to the top wafer surface 216. The nozzle 230 dispensing the rinse water 234 can be angled 248 relative to horizontal, i.e. the wafer top surface 216. In one embodiment, the first nozzle 230 can apply the rinse water 234 at an angle 248 of approximately 45 degree and where the second nozzle 232 applying IPA vapor can be vertical to the wafer surface 216. Initially in the rinse cycle, the first nozzle 230 (shown in dashed lines) can be positioned at the center of the water 250 and pointing toward the wafer edge 217. Initially in the rinse cycle, the IPA vapor nozzle 232 (also shown in dashed lines) can be offset from the position of the first nozzle 232.

The two nozzles 230 and 232 can pivot about a common pivot point 252 in fixed relationship to each other, i.e. the two nozzles 230 and 232 can maintain a fixed position relative to each other as the two nozzles 230 and 232 are pivoted over the wafer top surface 216. Each nozzle 230 and 232 can have a radius of pivot R1 and R2 respectively from the common pivot point 252. The nozzles 230 and 232 can maintain their relationship with each other during pivot by using electronic commands to the pivot mechanisms or, alternatively, the two nozzles can be physically attached together.

In the alternate embodiment, the wafer can rotate counter-clockwise (looking top down) while the nozzles 230 and 230 can pivot clockwise (looking top down). As shown, the two nozzles 230 and 232 can pivot out (clockwise) toward the wafer edge 217. By positioning the IPA vapor nozzle 232 to lag the rinse water nozzle 230, the IPA vapor 236 will contact the inboard side (i.e. closer to the center of wafer rotation 244) of the rinse water 254 that has been dispensed on the wafer 210. The counter clockwise rotation of the wafer 210 can further assist by translating the rinse water 236 on the wafer 210 into the IPA vapor 236 that is trailing the rinse water, i.e. is dispensed behind the rinse water relative to the direction of travel 256 and 258 for the two nozzles 230 and 232.

Returning to FIG. 2A, in one embodiment, each nozzle 230 or 232 can have an inner diameter of approximately in the range of 0.10-0.25 inch, the two nozzles 230 and 232 can be positioned approximately 0.1-0.50 inch apart edge to edge (i.e. nozzle outer edge to nozzle outer edge distance), and each nozzle 230 and 232 can be positioned approximately in the range of 0.1-1.0 inch above the wafer 210 during processing. A flow rate for IPA vapor with N₂ can be approximately 7 standard liters per minute (sim) and the IPA vapor 236 can exit the IPA vapor nozzle 232 at an approximate ambient temperature where the process chamber interior 242 pressure can be approximately 1 atmosphere throughout processing. Translation of the nozzles 230 and 232 across the wafer 210 can be approximately in the range of 4-10 centimeter per second (cm/sec) but the direction of travel may not be purely in the radial direction. However, a rate that the nozzles 230 and/or 232 travel purely in the radial direction (radial equivalent rate), resulting from this non-radial directed nozzle 230 and/or 232 movement can be approximately 6 cm/sec. Alternatively, if the two nozzles 230 and 232 are rotated, a rotation rate of approximately 9 degrees/sec while the wafer 210 is rotating at approximately 100-1000 rpm can be achieved.

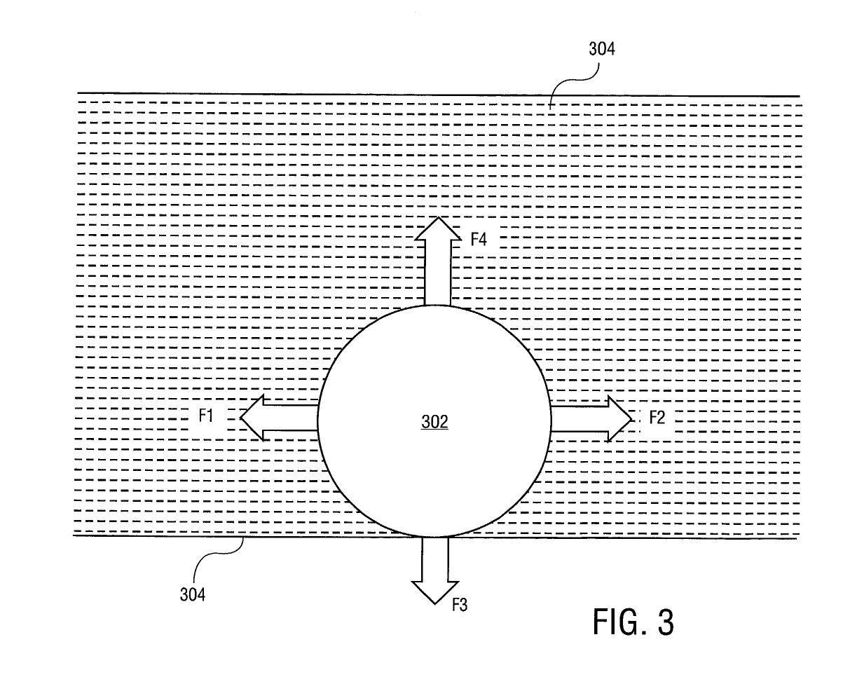

FIG. 3 is an illustration of one embodiment of forces acting on a particle 302 such as a silicate particle. Within the boundary layer 304, there can be at least four forces acting on the particle 302. A surface tension force (F1) from the rinse liquid with dissolved IPA vapor (F1) is represented on the left of the particle 302 where the DI water/IPA vapor can have a lower surface tension than just DI water. A second force (F2) can be the result of surface tension from DI water without IPA as shown on the right of the particle 302. A third force (F3) can be the Vander Waals attraction force from the surface 304 of the wafer onto the particle 302. A fourth force (F4) can be the surface tension force from the DI water above the particle 302 acting on the particle 302. The force of gravity can be minimal under these circumstances. F2 is stronger than F1, since F2 is the greater surface tension value from DI water acting onto the particle and F1 is the result of the lower surface tension value of IPA mixed with DI water. A net horizontal force results, i.e. the Marangoni force that can move the particles to the edge of the wafer.

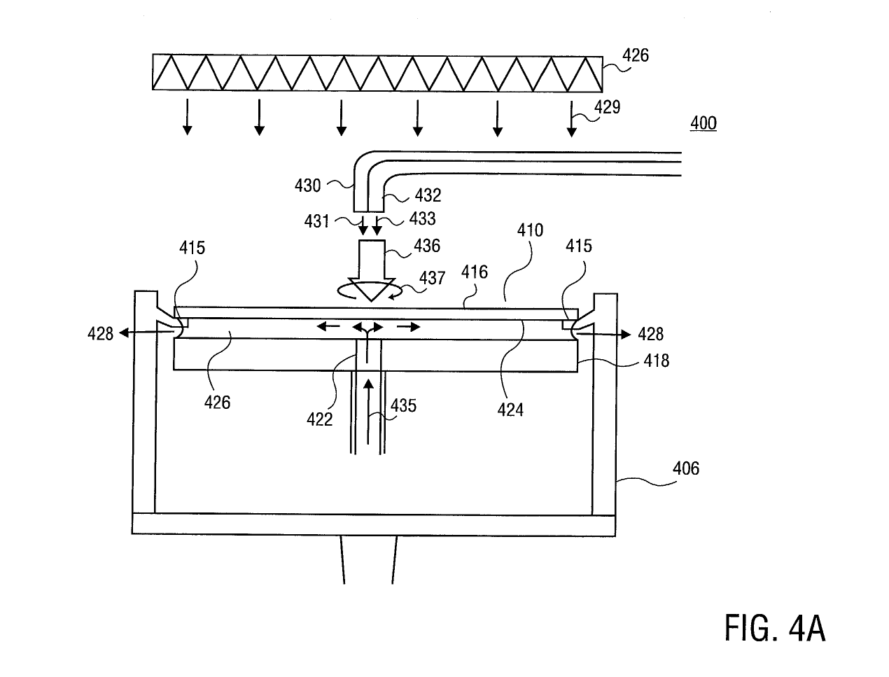

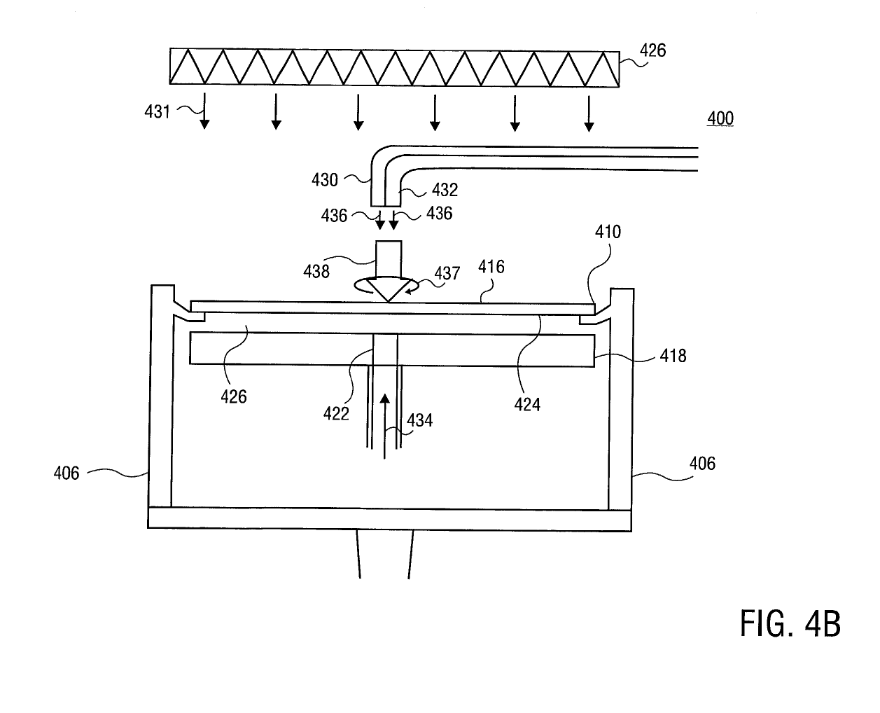

FIGS. 4A and 4B are illustrations of one embodiment of a wafer held in place in a wafer holding bracket during a cleaning operation. FIG. 4A is an illustration of the wafer held in place during a rinse operation. FIG. 4B is an illustration of the wafer held in place during a drying operation. The wafer 410 can be resting on local points 415 on the wafer holding bracket 406. Throughout the wafer cleaning process, clean air can be flowing down 431 onto the wafer 410 through an air filter 426 positioned at the top of the process chamber 400. Prior to initiating the cleaning cycles that include the rinse cycle, the wafer 410 can be maintained in the bracket 406 by gravity alone, i.e. the wafer 410 “free-floating” in the bracket 406 that does not restrain the wafer 410 against upward movement with any mechanical feature. During phases of the cleaning process, the wafer 410 can be rotated and can have chemicals flowing onto the top 416 and bottom 424 wafer surfaces simultaneously. To maintain the wafer 410 in a stable position during processing, the sum of all up and down forces acting on the wafer, such as, for example, from wafer rotation and chemical flows (gas or liquid), should act to apply a down force 436 onto the wafer 410 maintaining the wafer 410 in position within the bracket 406.

During a rinse phase, as shown in FIG. 4A, a greater down force 436 can be made up of several forces such as, for example, gravity, the flow 431 from the first nozzle 430 and/or flow 433 from the second nozzle 432, the air flow 429 from the filter 426, and from capillary forces 428 created by liquids 435 existing between the wafer 410 and the transducer plate 318 (such capillary forces acting when the wafer 410 attempts to move apart from the transducer plate 418). The up force can be from such events as, for example, the limited DI water flow 435 through the bottom feed-through hole 422 onto the wafer bottom surface 424 or from vibrations of the bracket 406 during rotation.

As illustrated in FIG. 4B, when the wafer 410 is being dried, liquid flow from the nozzles 430 and 432 can be stopped and replaced by flow through one or both nozzles 430 and/or 432 of an inert gas 436 such as nitrogen. In addition, the wafer 410 can be rotated at a rate greater than 1000 rpm to actively remove fluid from the wafer top surface 416 and the wafer bottom surface 424. At the same time, nitrogen 434 can flow through the bottom feed-through hole 422 onto the wafer bottom surface 424. With no fluid within the gap 426 and therefore no capillary forces 428 (FIG. 4A) acting on the wafer 410, Bernoulli forces relating to air flow within the gap 426 versus air flow on the wafer top surface 416 can be such as to provide a higher pressure at the wafer top surface 416 than in the gap 426. A result of this pressure differential can be to add to the down force 438.

Such Bernoulli forces have been demonstrated by experiments where in one embodiment a 300 mm wafer 410 was used in a one atmosphere environment, rotating at 1000 rpm, with a 25 mm gap above a fixed plate. With a pressure of one atmosphere or 101.3 kiloPascals (kPa) acting on the wafer top surface 416 a pressure of approximately 15 Pascals (Pa) has been found in the gap 426. The 300 mm wafer 410 rotating at 2000 rpm in the one atmosphere environment has been determined to still have one atmosphere acting on the top surface 416 but with a pressure of approximately 46 Pa in the gap 426.

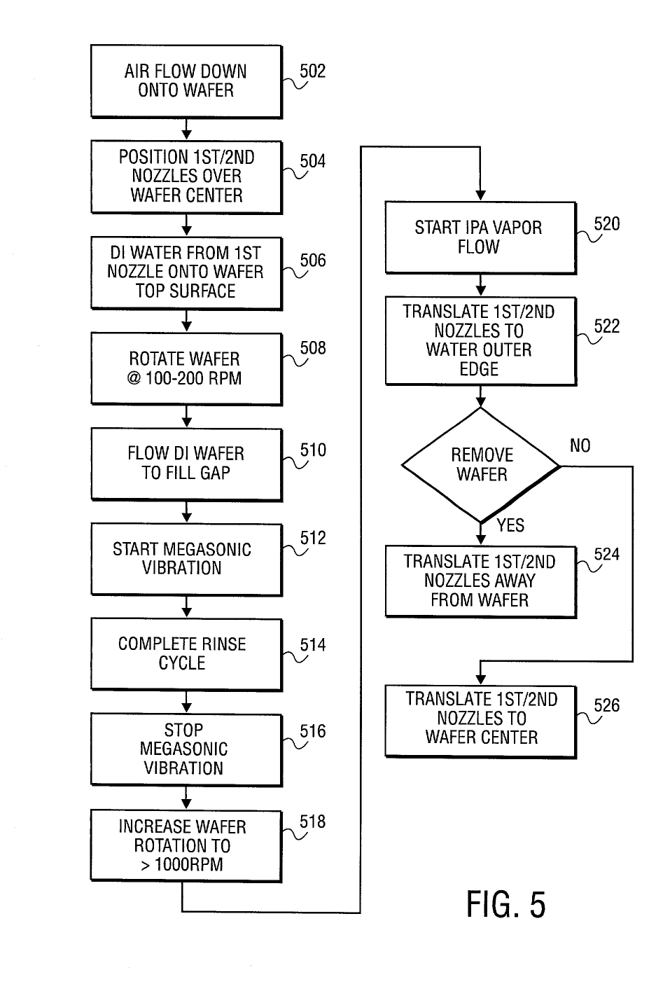

FIG. 5 is a flow diagram of one embodiment of a method for rinsing a wafer while maintaining the wafer in a bracket. The process method begins with a rinse cycle for a wafer, which begins after a cleaning process is finished, such as, for example an RCA type cleaning process. As throughout all stages of cleaning wafer, clean air can be forced through the filter to flow down onto the top of the wafer (operation 502). The first nozzle and the second nozzle can next be positioned over the center of the wafer (operation 504). After nozzle positioning, flow of DI water can begin from the first nozzle onto the wafer top surface near the wafer center (operation 506). The wafer holding bracket can rotate the wafer at an rpm of approximately 100-200 (operation 508). Once the wafer is rotating, a flow of DI water can occur through the transducer plate feed-port sufficient to fill (with little overflow) a gap between the transducer plate and the wafer (operation 510). When the gap is filled with DI water, the transducers on the transducer plate can be energized and megasonic vibrations can strike the rotating wafer bottom surface (operation 512). After the use of megasonics is complete (operation 514), energy to the transducers can be stopped (operation 516) and the wafer holding bracket rotation rate can be increased to over 1000 rpm (operation 518). With flow of DI water from the first nozzle maintained, a flow from a second nozzle of IPA vapor is initiated that contacts the wafer inboard of the contact point for flow of DI water from the first nozzle (operation 520). Next, both the first nozzle, flowing DI water, and the second nozzle, flowing IPA vapor, are translated across the rotating wafer from the wafer center to the wafer outer edge (operation 522). Translation of these two nozzles, flowing DI water followed by IPA vapor onto the wafer, creates a moving transition line for surface tension change. It is this dynamic transition line, i.e. transition from the surface tension of DI water to the surface tension of DI water mixed with IPA vapor, that creates the Marangoni force to act on the particles and dissolved aggregates forcing them to the wafer edge and off the wafer. The IPA vapor contacts the rinse water at an inboard side to always create the Marangoni force in the direction of rinse water removal, i.e. toward the water outer diameter. Once the nozzles have moved to the wafer outer edge, the nozzles can continue to translate away from the wafer to allow for wafer transfer out of the cleaning chamber (operation 524) or the nozzles can return to the wafer center to begin another phase of the cleaning process (operation 526).

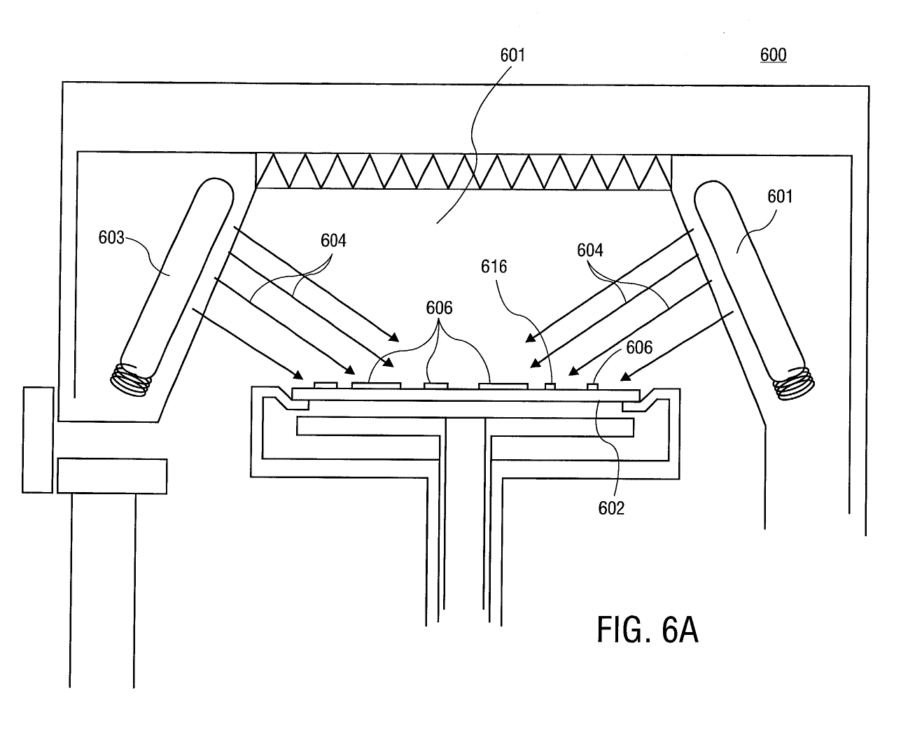

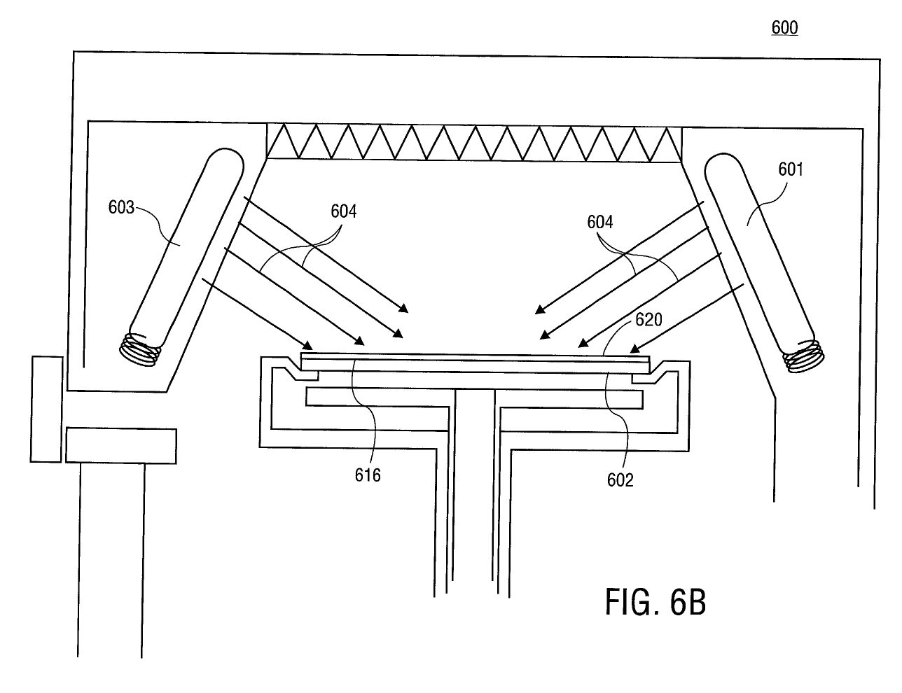

FIGS. 6A and 6B are illustrations of one embodiment of the present invention with UV light tubes. As shown in FIG. 6A, during the wafer cleaning process, banks of UV lamps 601 and 603 can be positioned within the single wafer cleaning chamber 600. The UV lamps can have a UV output wavelength in the approximate 150-300 nm range. UV radiation in the 150-300 nm wavelength range can dissociate O₂ existing in the chamber 600 where such dissociation can aid in the formation of ozone (O₃) and silicon dioxide (SiO₂). The UV light 604 can be directed onto the wafer top surface 616. The single wafer cleaning chamber 600 can maintain one atmosphere in the chamber 600 during processing and the ozone created can contact the wafer 602. Ozone is a reactive chemical, which can break down into smaller molecules any organic compounds 606 remaining on the wafer 602. These smaller molecules can be soluble in DI water to be washed away in the rinse cycle. The organic compounds 606 can be such compounds as, for example, residual chemistry from plastics from the clean room, alcohols, acetone from the photoresist process, spun-on dielectrics and sealants. The generalized reaction can be in the form of CHₓ+CzHy+O₃=CO₂+H₂O+small amount of other products. The ozone generated by the UV light 604 can also create a rinse solution having dissolved ozone, where the ozonated DI water (not shown) can further assist in the breakdown of any organic molecules.

As shown in FIG. 6B, in the single wafer cleaning chamber 600, UV light 604 can be applied to the wafer top surface 616 to speed up oxidation of exposed silicon. The UV light, at 150-300 nm, can dissociate oxygen to assist in forming silicon dioxide 620. Such oxidation can be well controlled and can form a thin approximately 2 Angstrom thick protective layer of silicon dioxide 620, which is approximately a single molecular layer, on top of any exposed silicon on the wafer top surface 616.

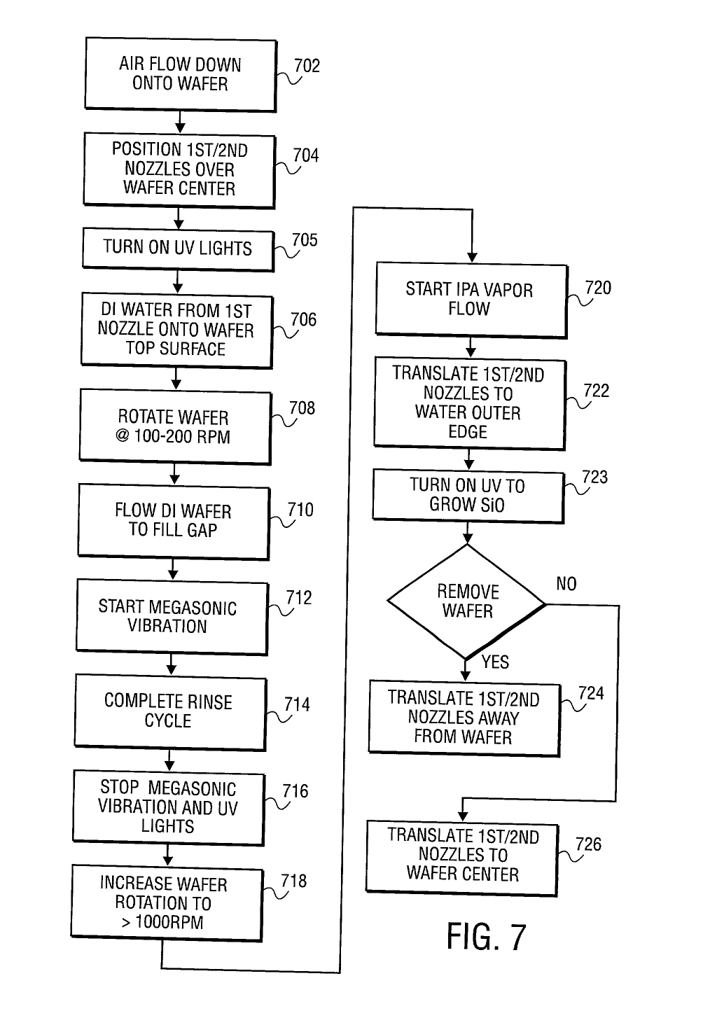

FIG. 7 is a flow diagram of one embodiment of a method for applying UV light to a wafer surface. This process method can apply UV light to the wafer top surface to break down organic compounds into smaller molecules that are easier to rinse off the wafer. This process can apply the UV light to the rinse solution creating ozonated DI water that can further break down the organic compounds on the wafer surface. In one embodiment, the method begins with a rinse cycle for a wafer, which can start after a cleaning process, such as, for example an RCA type cleaning process. Air can be forced through a filter to flow down onto the top of the wafer (operation 702). The first nozzle and the second nozzle are next positioned over the center of the wafer (operation 704). One or more banks of UV lights can be switched on to bathe the wafer with UV radiation (operation 705). Next, flow of DI water can begin from the first nozzle onto the wafer top surface near the wafer center (operation 706). The wafer holding bracket can rotate the wafer at an rpm of approximately 100-1000 (operation 708). Once the wafer is rotating at rpm, a flow of DI water can occur through the transducer plate feed-port just enough to fill (with little overflow) a gap between the transducer plate and the wafer (operation 710). When the gap is filled with DI water, the transducers on the transducer plate can be energized and megasonic vibrations can strike the rotating wafer bottom surface (operation 712). After the use of megasonics is complete (operation 714), energy to the transducers and the UV lamp arrays can be stopped (operation 716) and the wafer holding bracket rotation rate can be increased to over 1000 rpm (operation 718). With flow of DI water from the first nozzle maintained, a flow from a second nozzle of IPA vapor is initiated that contacts the wafer inboard of the contact point for flow of DI water from the first nozzle (operation 720). Next, both the first nozzle, flowing DI water, and the second nozzle, flowing IPA vapor, are translated across the rotating wafer from the wafer center to the wafer outer edge (operation 722). Translation of these two nozzles, flowing DI water followed by IPA vapor onto the wafer, creates a moving transition line for a change in surface tension. Once the nozzles have moved to the wafer outer edge, the UV lamps can again be turned on to accelerate the growth of a thin silicon oxide on the wafer top surface (operation 723). Finally, the nozzles can continue to translate away from the wafer to allow for wafer transfer out of the cleaning chamber (operation 724) or the nozzles can return to the wafer center to begin another phase of the cleaning process (operation 726).

Thus a method and apparatus for removing particles that are the products of etch and cleaning operations from within a thin boundary layer existing on a rotating wafer is described. A method and apparatus to maintain a wafer in a single wafer holding bracket has been described. A method and apparatus for using UV light in wafer cleaning and wafer oxidation has been described. And finally, an apparatus for reducing watermarks from forming on a wafer by angling a nozzle has been described. Although the present invention has been described with reference to specific exemplary embodiments, it will be evident that various modifications and changes may be made to these embodiments without departing from the broader spirit and scope of the invention as set forth in the claims. Accordingly, the specification and drawings are to be regarded in an illustrative rather than a restrictive sense.

What is claimed is:

1. A single wafer cleaning apparatus, comprising:
a rotatable bracket capable of holding a wafer;
a first fluid having a first surface tension;
a second fluid having a second surface tension lower than the first surface tension;
a first nozzle capable of applying the first fluid at a first location on the wafer positioned in the bracket;
a second nozzle capable of applying the second fluid at a second location on the wafer where the second location is inboard of the first location, and
the first nozzle and the second nozzle are capable of moving across the wafer to translate the first location and the second location from the wafer center to the wafer outer edge.

2. The apparatus of claim 1, wherein the second fluid is IPA vapor.

3. The apparatus of claim 1, wherein the first nozzle is separated from the second nozzle by an edge distance in the range of approximately 0.10-0.50 inch.

4. The apparatus of claim 1, wherein the first fluid is deionized water.

5. The apparatus of claim 1, wherein the first nozzle and the second nozzle are each capable of pivoting across the wafer at a rate of approximately 9 degrees/sec.

6. The apparatus of claim 5, the first nozzle is attached to the second nozzle.

7. The apparatus of claim 1, wherein the first nozzle and the second nozzle are each capable of translating across the wafer at a rate of approximately in the range of 6 cm/sec.

8. The apparatus of claim 1, wherein the first nozzle is capable of applying the first fluid at an angle that is approximately perpendicular to the wafer.

9. The apparatus of claim 2, wherein the second nozzle is capable of applying the IPA vapor at an angle that is approximately perpendicular to the wafer.

10. The apparatus of claim 2, wherein the second nozzle is capable of applying the IPA vapor at an angle up to 5 degrees from perpendicular to the wafer top surface, wherein the nozzle angle directs flow of IPA away from the wafer center.

11. The apparatus of claim 1, wherein the first nozzle is capable of applying the first fluid at an angle that is less than 90 degrees to the wafer.

12. The apparatus of claim 11, wherein the angle is approximately 45 degrees.

13. A method for removing particles from a single wafer, comprising:
rotating the wafer;
flowing a first fluid onto the wafer approximately at the wafer center;
flowing a second fluid having a lower surface tension than the first fluid onto the inboard side of the first fluid on the wafer; and
moving the flow of first fluid to the wafer edge.

14. The method of claim 13, further comprising moving the flow of the second fluid to the wafer edge while maintaining flow of the second fluid onto the inboard side of the rinse fluid.

15. The method of claim 13, wherein the second fluid is IPA vapor.

16. The method of claim 13, wherein the flow of the first fluid is moved at a rate of approximately 6 cm/second radial equivalent rate.

17. The method of claim 13, wherein the second nozzle moves to the wafer edge at a rate of 6 cm/sec radial equivalent rate.

18. The method of claim 2, wherein the IPA vapor is applied to the wafer at ambient temperature.

19. The method of claim 13, wherein the particles removed are silicates.

20. A method of maintaining a wafer in a bracket, comprising:
positioning the wafer in the bracket;
positioning a transducer plate beneath the bracket;
flowing a first chemical onto the wafer top surface creating a downward force onto the wafer
flowing a second chemical through the transducer plate to fill a gap between the transducer plate and the wafer to create a capillary force on the wafer; and

21. The method of claim 20, further comprising flowing a third chemical onto the wafer top surface creating a downward force on the wafer.

22. The method of claim 20, wherein the first chemical and the second chemical are DI water.

23. The method of claim 21, wherein the third chemical is IPA vapor.

24. A method of maintaining a wafer in a bracket, comprising:
positioning the wafer in the bracket;
positioning a transducer plate beneath the bracket;
placing a gas in a gap between the transducer plate the wafer;
rotating the wafer in the bracket; and
flowing a gas onto the wafer top surface, such that a pressure differential exists between the wafer top surface and the wafer bottom surface and a downward force onto the wafer results.

25. The method of claim 24, wherein the wafer is rotated at speeds of 1000 rpm or greater.

26. The method of claim 24, wherein the gas is air.

27. The method of claim 24, wherein the gas is an inert gas.

28. An single wafer cleaning chamber, comprising:
a rotatable wafer holding bracket;
a transducer plate; and
means for holding a wafer in the bracket during a cleaning cycle.

29. The single wafer cleaning chamber of claim 28, further comprising:
means for applying chemicals to a wafer surface.

30. The single wafer cleaning chamber of claim 28, further comprising:
means for removing contaminants from a wafer surface.

31. A single wafer cleaning chamber, comprising,
a rotatable wafer holding bracket;
a transducer plate;
a source of UV light capable of radiating to a top surface of a wafer positioned in the rotatable wafer holding bracket.

32. The single wafer cleaning chamber of claim 31, wherein the source of UV light is one or more banks of UV light bulbs positioned in the single wafer cleaning chamber and separated from the chamber interior by quartz glass.

33. The single wafer cleaning chamber of claim 31, wherein the source of UV light source is capable of producing UV light at a wavelength in the range of approximately 150-300 nm.

34. A method for use of a single wafer cleaning chamber, comprising:
placing a wafer in a wafer holding bracket within the single wafer cleaning chamber;
radiating the wafer top surface with UV light; and
processing the wafer through a wafer cleaning process.

35. The method of claim 34, further comprising,
creating ozonated DI rinse water by radiating the wafer top surface with UV light during a rinse cycle.

36. The method of claim 34, further comprising applying UV light to the wafer after a final dry cycle to grow a thin silicon oxide film on the wafer top surface.

37. A method for a single wafer cleaning chamber, comprising:
obtaining a wafer having contaminants on a top surface;
rotating the wafer in the single wafer cleaning chamber;
creating a Marangoni force on the contaminants that is directed to an outer diameter of the wafer by flowing chemicals onto the top surface of the wafer; and
moving the Marangoni force from a center of rotation of the wafer to the outer diameter of the wafer by moving the flow of chemicals.

38. The method of claim 37, further comprising:
applying UV light to the contaminants.
